(19) United States
(12) Patent Application Publication
(10) Pub. No.: US 2012/0035858 A1
(43) Pub. Date: Feb. 9, 2012

(54) DEVICE FOR ELECTRICALLY MEASURING AT LEAST ONE PARAMETER OF A MAMMAL'S TISSUE

(76) Inventors: Andreas Caduff, Zurich (CH); Alexander Megej, Zurich (CH); Mark Stuart Talary, Zurich (CH)

(21) Appl. No.: 13/257,788

(22) PCT Filed: Mar. 20, 2009
(86) PCT No.: PCT/CH2009/000100

§ 371 Date: Oct. 25, 2011

(51) Int. Cl. G06F 19/00

(52) U.S. Cl. 702/19

(57) ABSTRACT

The device measuring a parameter p that depends on the real and/or imaginary parts of the permittivity of body tissue operates at a frequency f where a temperature change affects the permittivity of free water only weakly. If the parameter p depends on the real part of the permittivity only, the frequency f should be between 6.2 and 10.1 GHz. If the parameter p depends on the imaginary part of the permittivity only, the frequency f should be between 25.5 and 36 GHz. If parameter p depends on the real and imaginary parts of the permittivity, the derivative of the parameter in respect to the real and imaginary parts of permittivity can be used to calculate an optimum frequency range.

### TECHNICAL FIELD

The invention relates to a device for measuring at least one parameter p depending on the real part ε′ and/or imaginary part ε″ of the dielectric permittivity of tissue, in particular skin, of a mammal, in particular a human. The method also relates to a method for operating such a device.

### BACKGROUND ART

Various important parameters of mammal tissue, in particular mammal skin, can be determined by measuring the response of the tissue to an applied electric field.

For example, WO 02/069791 describes a device for measuring blood glucose in living tissue. It comprises an electrode arrangement with a ground electrode and a signal electrode. A signal generator applies an electrical AC-signal of known voltage or current through a resistor to the electrodes, and a detector determines the voltage over or current through the electrodes. This voltage or current depends on the dielectric properties of the tissue, measured as an impedance or admittance which, as it has been found, is indicative of the glucose level within the tissue.

WO 2005/120332 describes another embodiment of such a device where a plurality of electrical fields is generated by applying voltages to different configurations of the electrode arrangement. This allows, for example, a reduction of the influence of surface effects on the measured signal.

A method for measuring water content of skin (skin hydration) with an applied electrical field is described in JP 56118654.

These techniques allow to measure a parameter p of living tissue, in particular the glucose level or water content, where this parameter is a function p(ε′, ε″) of the permittivity ε=ε′-i-ε″ of the tissue, with ε′(ω) and ε″(ω) being the real and imaginary parts of the permittivity. They rely on applying an electrode arrangement to a skin region of the tissue and generating an alternating electric field in the tissue. A signal depending on the bulk dielectric properties as seen by the electrode arrangement is measured. The measured signal is then processed, e.g. using pre-recorded calibration data, in order to obtain the characterizing parameter, such as the glucose level.

According to [3], various sources of erroneous measurements have been recognized for this type of experiments:
Sensitivity to the attachment techniques and quality of the contact (skin cleanliness, pressure, occlusion)
Location of the measurement site. Even the smallest lesions and skin scaling strongly affect the measurements
Different instruments have different sensitivity for different levels of water contents
The skin depth assessed seems to vary between devices and is not generally known
Environmental influence: Skin (Stratum Corneum) hydration strongly varies with the change of the room temperature and relative humidity.
Conductance of the skin is highly affected by the amount of sweat and by the sweat composition (electrolytes).

### DISCLOSURE OF THE INVENTION

It is a general object of the invention to provide a method and device of this type that has increased measurement accuracy.

This object is achieved by the device and method according to the independent claims. Accordingly the frequency f of the electric field is chosen such that

$$\vert ( \frac{\partial }{\partial {ɛ}^{′}} p ( {ɛ}^{′} , {ɛ}^{″} ) \cdot \frac{\partial }{\partial T} {ɛ}_{H 2 O}^{′} ( T , f ) + \frac{\partial }{\partial {ɛ}^{″}} p ( {ɛ}^{′} , {ɛ}^{″} ) \cdot \frac{\partial }{\partial T} {ɛ}_{H 2 O}^{″} ( T , f ) ) \cdot \frac{Δ T}{p ( {ɛ}^{′} , {ɛ}^{″} )} \vert < B \qquad ( 1 )$$

for a temperature T=34° C., a temperature deviation ΔT=4° C. and a threshold value B not larger than 0.05, wherein ε′_{H20} (T, f) and ε″_{H20}(T, f) are functions describing real and imaginary parts of the permittivity of water as a function of temperature T and frequency f.

This is based on the understanding that the real and imaginary parts ε′ and ε″ of the permittivity of the tissue are predominantly influenced by the real and imaginary parts of the permittivity ε_{H2O} of water. This is because water is one of the major components of the tissue and it has a high permittivity. The permittivity of water strongly depends on temperature T as well as frequency f. While the frequency f is controlled by the measurement device and therefore well known, the temperature T within the tissue can vary and is, often, not well known. Prior art approaches therefore concentrate on measuring the temperature T in order to subsequently correct the measured parameter p. The present approach, on the other hand, is based on the idea that the frequency f should be chosen such that, in linear approximation, the derivative of the function p in respect to temperature is zero. This frequency can be calculated from the knowledge of the function p(ε′, ε″) as well as from the known dispersion and temperature dependence of ε′_{H20}(T, f) and ε″_{H20}(T, f).

The frequency range can be formulated explicitly if the parameter p depends on the real part ε′ of the permittivity of the body tissue, but is substantially independent of the imaginary part ε″ of said permittivity. In that case, as shown below, the frequency f should be in a range between 6.2 and 10.1 GHz.

Similarly, if the parameter p depends on the imaginary part ε″ of the permittivity of the body tissue, but is substantially independent of the real part ε′ of the permittivity, the frequency f should be in a range between 25.5 and 36 GHz.

The present invention is particularly suited for the measurement of skin hydration, but may also be applied for other measurements based on the response of the tissue to an applied electrical field.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 is a sectional view, perpendicular to the longitudinal axis of the waveguide, of a coplanar waveguide,

FIG. 2 is a sectional view, perpendicular to the longitudinal axis of the waveguide, of a conductor-backed coplanar waveguide,

FIG. 3 shows a graphical representation of the measurement system based on the conductor-backed coplanar waveguide (CBCPW),

FIG. 4 is a block diagram of a device for measuring a parameter,

FIG. 5 shows the dependence of the real part of the free water permittivity on temperature and frequency,

FIG. 6 shows the dependence of the imaginary part of the free water permittivity on temperature and frequency,

FIG. 7 shows the real part of the permittivity of pure water for selected frequencies as a function of temperature,

FIG. 8 shows the permittivity as a function of frequency for different saline solutions,

FIG. 9 shows the real part of the permittivity of pure water for selected temperatures as a function of frequency,

FIG. 10 tabulates the frequency ranges corresponding to acceptable variations of the real and imaginary parts of the permittivity over a range of 30 to 38 ° C.,

FIG. 11 shows the imaginary part of the permittivity of pure water for selected frequencies as a function of temperature,

FIG. 12 shows the imaginary part of the permittivity of pure water for selected temperatures as a function of frequency,

FIG. 13 the block diagram of a frequency mixer.

### MODES FOR CARRYING OUT THE INVENTION

In the following, the invention is described in view of a device measuring skin properties. It must be understood, though, that this technique can also be applied to measurements deeper within a mammal's body, e.g. using embedded electrodes.

### 1. Sensor Implementations

### 1.1. Introduction

In an advantageous embodiment, the present invention relies on using a sensor device having at least one coplanar waveguide as described under section 1.2. It must be noted, though, that the present invention can also be carried out with other electrode geometries, such as with the device disclosed in WO 2005/120332.

The sensor device is applied to the skin region under test with the electrode arrangement being close to the topmost layer of the skin. The electrode arrangement is then used to generate alternating electrical fields within the skin region. Advantageously, the device comprises electrodes with different gap widths in order to generate electrical fields with differing penetration into the tissue, which allows to record a depth profile of the skin properties.

Each field will see an average effective permittivity ε_{eff}, depending on how far it penetrates into the skin/tissue. This effective permittivity describes the combination of the linear response (polarization) of the tissue and the linear response of the electrode substrate to the field. It is composed of the permittivity of the electrode substrate and the average permittivity ε the tissue.

In a next step, a value m is measured for each electrode pair. This value may e.g. be the electrical impedance Z or capacitance C of the electrodes, or a phase shift or damping coefficient for a signal passing through the electrodes, and it will depend on the effective permittivity experienced by the electrodes. A specific example is described in sections 1.2 and 1.3 below.

Using e.g. the techniques as described below, the measured value m can be converted, by means of suitable calculations, into the desired parameter p. The parameter p may e.g. be equal to the average tissue permittivity e (or to the real or imaginary part ε′ or ε″ of the same) or to an estimate of the water concentration of the tissue. This is described in more detail in section 1.4 below.

### 1.2. Coplanar Waveguide Transmission Lines

As mentioned, the present invention is advantageously carried out by means of an electrode arrangement comprising a coplanar waveguide transmission line. Such transmission lines are especially suited for the high frequencies f used in the present invention. Details of coplanar waveguide transmission lines are described in the following sections.

### 1.2.1. DEFINITION

The term “coplanar waveguide” (CPW) as used in this text and the claims is to be interpreted as an arrangement of an elongate center strip electrode (signal electrode) between and at a distance from two ground electrodes. The signal electrode is much longer than it is wide. The signal and ground electrodes are mounted to the same surface of a non-conducting support. Optionally, a further ground electrode may be located on the opposite side of the support (an arrangement called “conductor-backed coplanar waveguide”, CBCPW). The electrodes may extend along a straight line, or they may be curved (e.g. in the form of a spiral) or polygonal (e.g. in the form of an L or a U).

Advantageously, the ground electrodes are much wider than the signal electrode as this design provides better field localization and is easier to model.

Furthermore, also advantageously, the width of the electrodes are constant along their longitudinal extension, and also the ground geometry does not change along the CPW, as this design is easiest to model. However, it may also be possible to vary these parameters along the CPW, e.g. by periodically changing the width of the signal electrode.

### 1.2.2. EXAMPLES

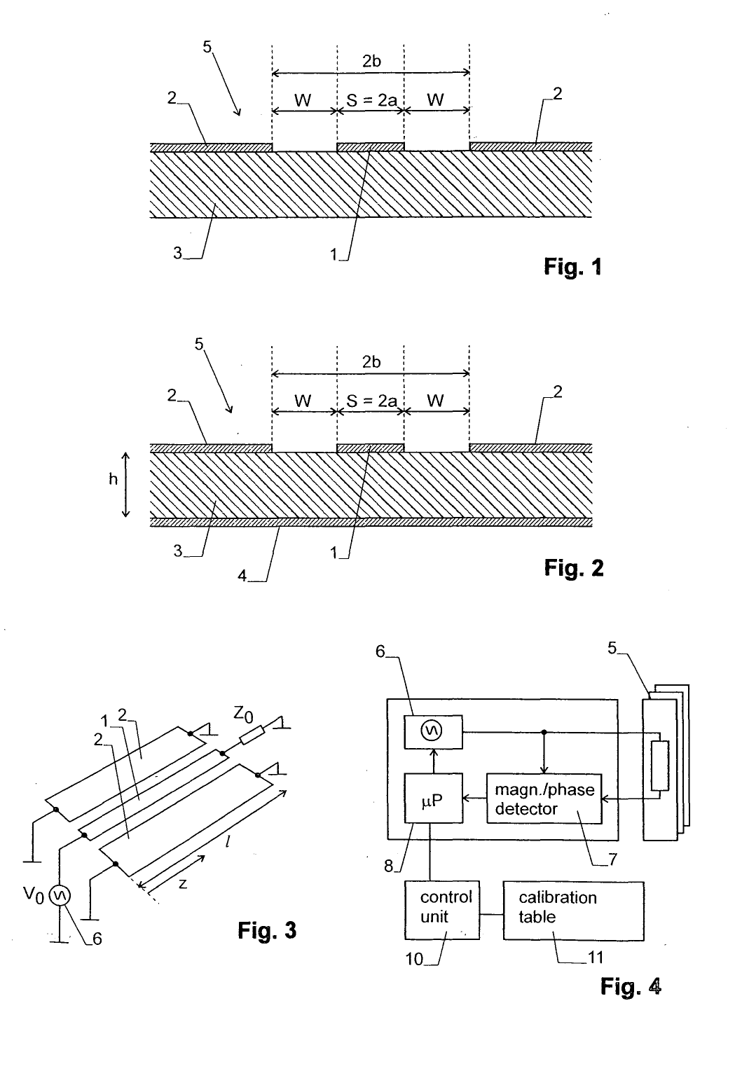

As shown in FIG. 1, an embodiment of a CPW on a dielectric substrate comprises a center strip electrode 1 conductor with (ideally) semi-infinite ground electrodes 2 on either side. Center strip electrode 1 and the ground electrodes 2 are arranged on a dielectric support 3. This structure supports a quasi-TEM (transversal electro-magnetic) mode of propagation. The coplanar waveguide 5 offers several advantages over a conventional microstrip line: First, it simplifies fabrication; second, it facilitates easy shunt as well as series surface mounting of active and passive devices; third, it eliminates the need for wraparound and via holes, and fourth, it reduces radiation loss. Furthermore the characteristic impedance is determined by the ratio of a/b, so size reduction is possible without limit, the only penalty being higher losses. In addition, a ground plane exists between any two adjacent lines; hence cross talk effects between adjacent lines are very weak.

The quasi-TEM mode of propagation on a CPW 5 has low dispersion and, hence, offers the potential to construct wide band circuits and components.

FIG. 1 shows a conventional CPW, where the ground planes are of semi-infinite extent on either side. However, in a practical circuit the ground electrodes are made with a finite extent.

In an alternative embodiment, a conductor-backed CPW, as shown in FIG. 2, can be used. It has an additional bottom ground electrode 4 at the surface of the substrate 3 opposite to electrodes 1 and 2. This bottom ground electrode not only provides mechanical support for the substrate but also acts as a heat sink for circuits with active devices. It also provides electrical shielding for any circuitry below support 3. A conductor backed CPW is advantageously used within this work.

### 1.3. Forward Problem for Conductor-Backed CPW (CBCPW)

In the following, the CBCPW 5 of FIG. 2 will be considered. The signal line has the width S and the gap width between signal and ground electrodes is W. The following annotations are used as well: S=2a and S+2W=2b.

First, the forward problem of the transmission line has to be solved, i.e. the calculation of the effective permittivity ε_{eff} of the system depicted in FIG. 2. Usually, the shown configuration is used with air on top within the high-frequency systems (εᵣ₁=1). In measurement applications, the material under test (MUT) with permittivity εₓ is placed on top of the transmission line (εᵣ₁=εₓ). Permittivity εₓ corresponds to the average permittivity ε of the tissue.

In order to be able to analytically state some simple relationships for the CPWs, a number assumptions and approximations have to be made. The main assumption is that the quasi-TEM (transversal electro-magnetic) wave propagation is dominant on the transmission line. This assumption implies that the losses in the metal strips and dielectric materials are low. Often, this is not the case for human tissues. However, the analytic expressions allow to quickly analyze the sensor functionality before proceeding to the rigorous computer-aided full-wave analysis.

Based on this approximation, the analysis of Wen [1] can be expanded to the structure under consideration employing the procedure proposed by Gevorgian [2].

The effective permittivity as seen by the transmission line in FIG. 2 can be expressed by

ε_{eff}=1+q₁(εᵣ−1)+q₂(εₓ−1) (1.1)

with εᵣ being the permittivity of support 3 and wherein

$$\begin{matrix}{q}_{1} = \frac{1}{1 + \frac{K ( {k}_{0} )}{K ( {k}_{0 \cdot }^{′} )} \cdot \frac{K ( {k}^{′} )}{K ( k )}} ; & ( 1.2 ) \\ {q}_{2} = \frac{1}{1 + \frac{K ( {k}_{0}^{′} )}{K ( {k}_{0} )} \cdot \frac{K ( k )}{K ( {k}^{′} )}} . & ( 1.3 )\end{matrix}$$

The functions K(x) in Eqs. 1.2 and 1.3 are the complete elliptic integrals of the first kind. Re-arranging the Eqs.1.2 and 1.3, the effective permittivity of the system can be stated as:

$$\begin{matrix}{ɛ}_{eff} = {ɛ}_{r} \cdot {q}_{1} + {ɛ}_{x} \cdot {q}_{2} & ( 1.4 ) \\ = \frac{{ɛ}_{r}}{1 + \frac{K ( {k}_{0} )}{K ( {k}_{0}^{′} )} \cdot \frac{K ( {k}^{′} )}{K ( k )}} + \frac{{ɛ}_{x}}{1 + \frac{K ( {k}_{0}^{′} )}{K ( {k}_{0} )} \cdot \frac{K ( k )}{K ( {k}^{′} )}} ; & ( 1.5 )\end{matrix}$$

The parameters kᵢ depend on the structure geometry and are defined as follows:

$$\begin{matrix}{k}_{0} = \frac{S}{S + 2 W} = a / b , & ( 1.6 ) \\ {k}_{0}^{′} = \sqrt{1 - {k}_{0}^{2}} ; & ( 1.7 ) \\ k = \frac{tan h ( \frac{π \cdot a}{2 h} )}{tan h ( \frac{π \cdot b}{2 h} )} , & ( 1.8 ) \\ {k}^{′} = \sqrt{1 - {k}^{2}} . & ( 1.9 )\end{matrix}$$

The characteristic impedance of the transmission line can then be calculated to:

$${Z}_{L} = \frac{60 π}{\sqrt{{ɛ}_{eff}}} \cdot {[ \frac{K ( k )}{K ( {k}^{′} )} + \frac{K ( {k}_{0} )}{K ( {k}_{0}^{′} )} ]}^{- 1} . \qquad ( 1.10 )$$

### 1.4. Permittivity Measurements Using CPW Lines

Due to several boundary conditions, such as size, form (planarity), bandwidth of operations, simplicity, non-invasiveness, the transmission-line technique is employed here. This technique is based on the fact that the wave propagation along the line is strongly affected by the permittivity of the dielectric material supporting the line. There are numerous publications which describe various aspects of the utilisation of this method for material characterisation from theoretical considerations of the inverse problem [7, 8] to practical sensor implementations [9-11].

Using Eq. (1.4), the inverse problem of the determination of the permittivity εᵣ₁=εₓ can be solved using the following equation:

$${ɛ}_{x} = \frac{1}{{q}_{2}} ( {ɛ}_{eff} - {ɛ}_{r} \cdot {q}_{1} ) , \qquad ( 1.11 )$$

where q₁ and q₂ are defined by Eqs. (1.2) and (1.3), respectively.

### 1.4.1. Theory of the Sensor Operations

The unknown effective permittivity ε_{eff} of the measurement system has to be determined experimentally. As described in the preface to this subsection, there are various methods to do so. FIG. 3 demonstrates graphically an advantageous method. A signal generator 6 provides a sinusoidal RF signal, which is applied to the input of center strip electrode 1. The voltage V(l) at the output of the center strip electrode 1 is measured. The propagating wave is attenuated and its velocity is reduced due to the higher permittivity of the medium in comparison to the free space. The following equation describes the voltage variation along the transmission line:

V(z)=Vₚ(z)·e^{-γ·z}+Vᵣ(z)·hu y·z (1.12)

where Vₚ(z) and Vᵣ(_{z}) are the amplitudes of the signals propagating forth and back along the line. In case of the line termination with the specific impedance (usually 50Ω), the amplitude Vᵣ(z) of the reflected wave vanishes. Then, the voltage at the termination can be stated as

V(l)=V_{α}·e^{-γ·l} (1.13)

The transfer function of the transmission line is then

$$\begin{matrix}H = {e}^{- γ \cdot l} \cdot {e}^{j \cdot ω \cdot t} = {e}^{- γ \cdot l + j \cdot ω \cdot t} = & ( 1.14 ) \\ = {e}^{- α \cdot l} \cdot {e}^{j \cdot ( ω \cdot t - β \cdot l )} & ( 1.15 )\end{matrix}$$

Comparing the transfer function with the forward transmission coefficient S₂₁=|S₂₁|·e^{-jφ}, the following relationships for the attenuation and the phase of the measured signal at the CPW output can be defined:

$$\begin{matrix}α = - \frac{\vert {S}_{21} \vert}{l \cdot 20 log e} , & ( 1.16 ) \\ ϕ = 360 ° \cdot l \cdot f \sqrt{{μ}_{0} {ɛ}_{0}} \cdot \sqrt{{ɛ}_{eff}} . & ( 1.17 )\end{matrix}$$

It has to be noted at this point that the measured phase delay φₘ is usually higher than the value calculated in Eq. (1.17) due to the non-ideal matching of the measurement transmission line.

Combining Eqs. (1.11 and (1.17), the unknown permittivity εₓ of the material under test can be defined as

$${ɛ}_{x} = \frac{1}{{q}_{2}} ( {[ \frac{{ϕ}_{0} - {ϕ}_{m}}{360 °} \cdot \frac{1}{l \cdot f \cdot \sqrt{{μ}_{0} {ɛ}_{0}}} ]}^{2} - {ɛ}_{r} \cdot {q}_{1} ) , \qquad ( 1.18 )$$

where φₘ is the measured phase delay by the sensor hardware in degrees, which differs from the phase delay over the transmission line. The base phase shift φ_{α} is a constant stant defined by the sensor hardware. It has to be determined by a calibration procedure as described later.

### 1.4.2. Sensor Hardware

FIG. 4 shows the basic block diagram of the device. A microwave signal is provided by an AC signal generator 6 and then applied to a first end (input end) of signal line 1 of coupling structure 5, which is brought in contact with the skin of a living mammal, in particular a human. Coupling structure 5 is a CPW, in particular a CBCPW as described above, with the signal being applied as shown in FIG. 3. FIG. 4 schematically shows that there can be several such coupling structures.

The voltage at the second end (output end) of center strip electrode 1 of coupling structure 5 is fed to a magnitude/phase detector 7. In the present embodiment, this circuit compares the input and output signals of center strip electrode 1 and generates one or two DC signals, whose voltage is proportional to the magnitude ratio and/or phase difference between them. A microcontroller 8 digitizes and stores the measured data, which then can be used as the basis for calculations of the measure of interest. This sensor system is basically a simplified VNA (Vector Network Analyzer) on a board measuring the magnitude and phase of the forward transmission coefficient S₂₁.

It must be noted that the device is structured to carry out a measurement at a well defined, optionally tunable, frequency f. For example, signal generator 6 generates a pure sine signal and/or narrow bandpass filters are provided in magnitude/phase detector 7.

Further, a control unit 10 is provided for processing the measured parameters mᵢ and for calculating the parameter p therefrom. Control unit 10 may be implemented as part of microcontroller 8 or it may be a separate unit, such as an external computer. Detector 7, microcontroller 8 and control unit 10 together form a measuring unit connected to the electrode arrangement for measuring the parameter p.

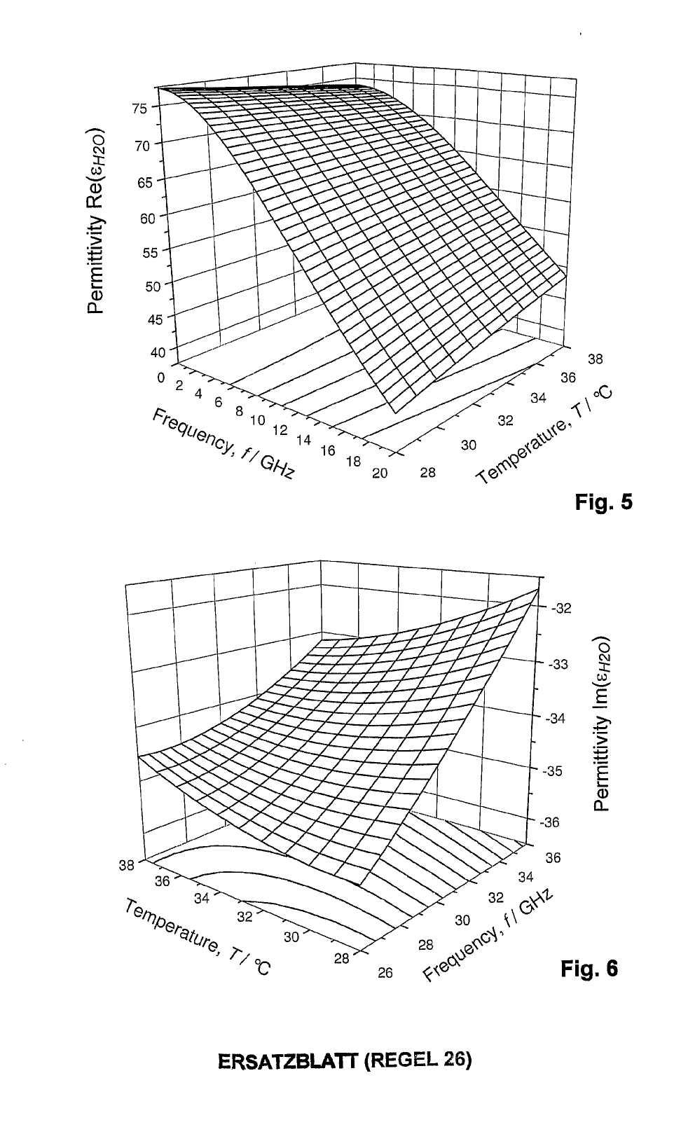

When several CPWs are part of the sensor device, a single signal generator 6 as shown in FIG. 5 can be used for feeding a common signal to all of them such that all CPWs are in operation at the same time. Alternatively, signal generator 6 may be adapted to subsequently feed a signal to each one of the CPWs such that the CPWs are operated in sequence, thereby minimizing crosstalk. Similarly, a measuring unit with several magnitude/phase detectors 7 may be provided, i.e. one detector 7 for each CPW, or a single magnitude/phase detector 7 can be switched between the output ends of the CPWs to sequentially measure the signals from all of them.

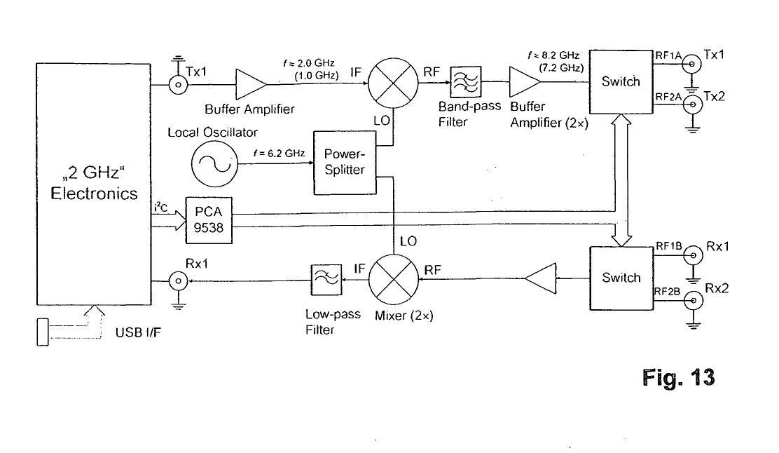

As will be explained below, advantageous frequencies f will be in the order of 8 or even 30 GHz. Frequency mixing techniques can e.g. be used to carry out measurements at such high frequencies. A block diagram of a frequency mixer for operating at 7.2 or 8.2 GHz is shown in FIG. 13.

A unit called “2 GHz Unit” generates an RF signal with a frequency of 1 or 2 GHz at a terminal Tx. At the same time, another RF signal as an intermediate frequency (IF) with frequency of some 6.2 GHz is generated by a local oscillator (LO). Via a power splitter it is fed to the mixer. The two signals (IF and LO) are mixed by a double-balanced mixer to generate an RF signal of 7.2 or 8.2 GHz, which is then amplified by a buffer amplifier and fed to the DUT (device under test, i.e. the electrode arrangement) via another single pole double throw (SPDT) switch. Before the buffer amplifier, a band-pass filter is placed to filter out unwanted harmonics.

The received signal is first amplified and then downconverted to the IF frequency using the LO signal. Both the transmitted IF and the received IF signals are compared employing an AD8302 magnitude/phase detector within the “2 GHz” electronics. Its output DC signal is transformed into the digital domain and transferred to the microcontroller for the evaluation. The phase difference between the reference and the measurement IF signals contains information about the phase delay in the device under test. A calibration with a known system (e.g. air- or water-loaded line) can help to determine the absolute value of the phase delay of interest.

### 1.5. Complex Permittivities

The above calculations are made under the assumption that losses are low, i.e. the imaginary part of the permittivity εₓ of the tissue is negligible. If this assumption is not made, the complex permittivity ε of the tissue as a function of the measured phase delay φₘ and signal attenuation through the transmission line can e.g. be obtained using rigorous computer-aided full-wave analysis.

### 1.6. Determining the Measured Parameter p

Depending on the application, the measured parameter p can e.g. be the average permittivity ε(=εₓ) of the tissue, which can be obtained from the method described above. Alternatively, it may e.g. be any value derived from the average permittivity ε.

For example, when the device comprises several CPWs with differing gap widths W, the average permittivities ε measured by the differing CPWs can be combined in order to estimate the average permittivity at a certain depth below the skin.

Also, the measured average permittivity may be further processed by control unit 10, e.g. in order to calculate a glucose value of the tissue using the techniques described in WO 02/069791 and WO 2005/120332. In that case, the measured parameter p would be a glucose level.

Also, instead of calculating the average permittivity ε explicitly, the measured signal p could also be the phase delay φₘ and/or the signal attenuation through the transmission line, or any value derived therefrom.

In any of these cases, the measured signal p will be a function p(ε′, ε″) of the permittivity ε=ε′-i·ε″, with function p depending on the real part ε′ and/or the imaginary part ε″ of the permittivity of the tissue.

### 2. Measurement Frequency

Function p introduced in section 1.6 above depends on the frequency f of the applied electric field as well as on the temperature T of the tissue.

As it has been found, one primary reason for this dependence is the temperature and frequency dependence of the permittivity ε_{H2O} of (free) water because the tissue permittivity e depends strongly on the permittivity of the water within the tissue.

The graphs in FIGS. 5 and 6 show the real and imaginary parts ε′_{H2O} and ε″_{H2O}, respectively, for different frequencies f and temperatures T, which were calculated using the expression derived by Kaatze [4] for pure bulk water. The dielectric properties of the so-called bound water within the living tissues strongly depend on the materials the water molecules are bound to. The globule proteins, for example, increase the permittivity of the solution [5], whereas the glucose rather decreases this value [6]. Nevertheless, the temperature behaviour of the aqueous solutions remains quantitatively the same as described above for the bulk water.

As can been seen from FIGS. 5 and 6, the permittivity of water strongly depends not only on the frequency f, but also on the temperature T. However, as one can easily recognize, there exist frequencies at which the permittivity (real part) of water demonstrates only weak variation with temperature provided a limited range of temperatures can be considered. For mammals, in particular humans, the temperature range can be limited to some 30-38° C.

This allows to select a suitable frequency f at which the influence of temperature on the permittivity of water is small. In the following, this is first illustrated for the example of a measured parameter p depending on the real part of the tissue permittivity only, then for the example of a measured parameter p depending on the imaginary part of the tissue permittivity only. Finally, this mechanism is generalized to cases where the measured parameter p significantly depends on both the real and imaginary part of the tissue permittivity.

### 2.1. Parameter p Depends on the Real Part of the Tissue Permittivity

If parameter p depends on the real part e′ of the tissue permittivity only, in particular if p=ε′, or, at least, if the dependence of parameter p on the imaginary part ε″ can be neglected, the frequency f should be set to a value where ε′_{H2O}=Re(ε_{H2O}) varies only slightly with temperature.

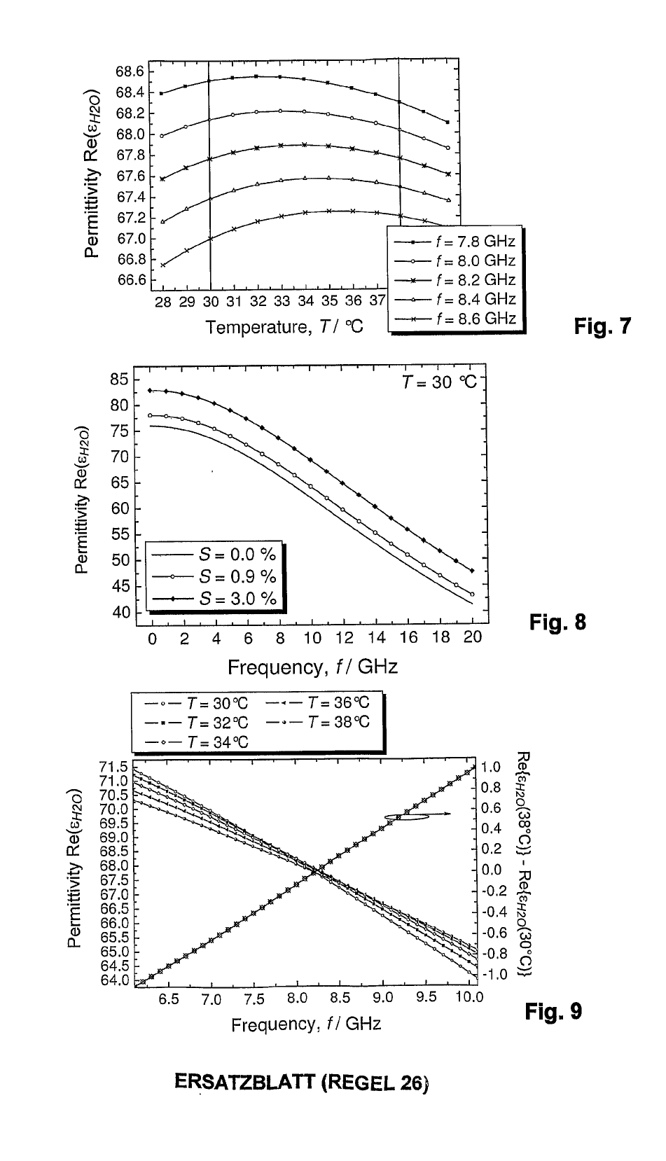

This is illustrated in FIG. 7, where the temperature dependence of ε′_{H2O} is depicted for selected frequencies in the range between 7.8 GHz and 8.6 GHz.

The permittivity only changes between 67.7 and 67.8 within the temperature range of 30-38° C. and for frequency f=8.2 GHz. The permittivity variation is well below 0.1 and probably even below the accuracy of the system.

Its can be concluded from the above consideration that the measurement frequency should be around f=8.2 GHz if the bulk water is the material of interest.

However, the bulk water (or solutions of it) is only a part (even if a major one) of the water body compositions. Depending on the type of body tissue, the bound water amounts to some 0-40% of the total water content. The bound water itself can exhibit permittivity higher or lower than that of the bulk water depending on the type of the bond. It is in the nature of bound water that its permittivity cannot be directly measured. Measurements and modeling of saline solutions showed that the permittivity of the isotonic solutions does not significantly differ from the value of the bulk water as shown in FIG. 8 [7].

In order to assess a suitable range of frequencies f to be used, the value of ε′_{H2O} was calculated, as well as the difference between the real part of the permittivities at 38° C. and 30° C. The result of these calculations is shown in FIG. 9.

Depending on the value of the tolerable deviation of the real part permittivity over the temperature range of 30° C. to 38° C., the range of allowable frequencies can be obtained from columns 1 and 2 of the table of FIG. 10. For example, if the acceptable deviation of ε′_{H2O} over the range of 30° C. to 38° C. is +/−0.25, the allowable frequency range is 7.7-8.7 GHz.

Since, in many applications, an acceptable variation of ε′_{H2O} is in the order of +/−1, the range of frequencies is therefore 6.2-10.1 GHz. Advantageously, though, the range is 7.2-9.2 GHz, in particular 7.7-8.7 GHz.

### 2.2. Parameter p Depends on the Imaginary Part of the Tissue Permittivity

Similarly, if the dependence of parameter p on the real part ε′ can be neglected, in particular if p=ε″, the frequency f should be set to a value where ε″_{H2O}=Im(ε_{H2O}) varies only slightly with temperature.

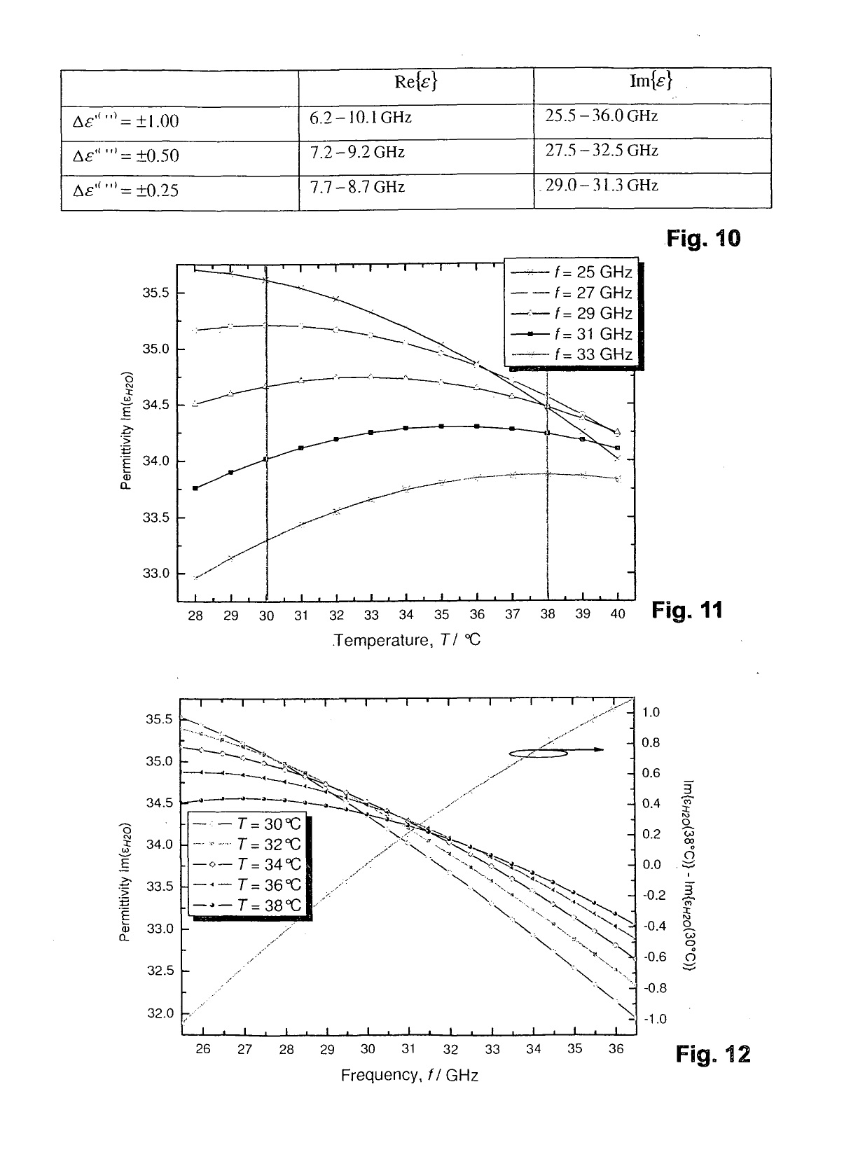

This is illustrated in FIG. 11 where the temperature dependence of ε″_{H2O} is depicted for selected frequencies in the range between 25 GHz and 33 GHz. Again, it is found that e.g. at 29 or 31 GHz, the dependence of ε″_{H2O} on temperature is minimal, while it e.g. becomes larger at 25 GHz.

FIG. 12 shows the corresponding value of ε″_{H2O} as a function of frequency for differing temperatures, as well as the difference between the imaginary part ε″_{H2O} of the permittivities at 38° C. and 30° C.

The allowable frequency range for a given acceptable deviation of ε″_{H2O} over the range of 30° C. to 38° C. is listed in columns 1 and 3 of the table of FIG. 10. For example, if the acceptable deviation of ε″_{H2O} over the range of 30° C. to 38° C. is +/−0.25, the allowable frequency range is 29.0-31.3 GHz.

Since, in many applications, an acceptable variation of ε″_{H2O} is in the order of +/−1, the range of frequencies is therefore 25.5-36 GHz. Advantageously, though, the range is 27.5-32.5 GHz, in particular 29-31.3 GHz.

### 2.3. Parameter p Depends on the Real and Imaginary Parts

In sections 1.1 and 1.2, it was assumed that parameter p depends on ε′ or ε″ only. However, parameter p may depend on both, the real and imaginary parts of the tissue permittivity, i.e. it is a function p(ε′, ε″).

In linear approximation, a temperature induced change in the permittivity will give rise to a variation Δp in the parameter p as follows:

$$\begin{matrix}Δ p = \frac{d}{d T} p ( {ɛ}^{′} , {ɛ}^{″} ) \cdot Δ T \\ = ( \frac{\partial }{\partial {ɛ}^{′}} p ( {ɛ}^{′} , {ɛ}^{″} ) \cdot \frac{\partial }{\partial T} {ɛ}^{′} ( T , f ) + \frac{\partial }{\partial {ɛ}^{″}} p ( {ɛ}^{′} , {ɛ}^{″} ) \cdot \frac{\partial }{\partial T} {ɛ}^{″} ( T , f ) ) \cdot Δ T\end{matrix} \qquad ( 3.1 )$$

Under the assumption that the temperature dependence of the tissue permittivity ε is substantially equal to the temperature dependence of free water, we can write

$$Δ p = ( \frac{\partial }{\partial {ɛ}^{′}} p ( {ɛ}^{′} , {ɛ}^{″} ) \cdot \frac{\partial }{\partial T} {ɛ}_{H 2 O}^{′} ( T , f ) + \frac{\partial }{\partial {ɛ}^{″}} p ( {ɛ}^{′} , {ɛ}^{″} ) \cdot \frac{\partial }{\partial T} {ɛ}_{H 2 O}^{″} ( T , f ) ) \cdot Δ T \qquad ( 3.2 )$$

The relative error Δp/p is therefore given by

$$\frac{Δ p}{p ( {ɛ}^{′} , {ɛ}^{″} )} = ( \frac{\partial }{\partial {ɛ}^{′}} p ( {ɛ}^{′} , {ɛ}^{″} ) \cdot \frac{\partial }{\partial T} {ɛ}_{H 2 O}^{′} ( T , f ) + \frac{\partial }{\partial {ɛ}^{″}} p ( {ɛ}^{′} , {ɛ}^{″} ) \cdot \frac{\partial }{\partial T} {ɛ}_{H 2 O}^{″} ( T , f ) ) \cdot \frac{Δ T}{p ( {ɛ}^{′} , {ɛ}^{″} )} \qquad ( 3.2 )$$

Assuming that the relative error should be below a threshold B, we have

$$\vert ( \frac{\partial }{\partial {ɛ}^{′}} p ( {ɛ}^{′} , {ɛ}^{″} ) \cdot \frac{\partial }{\partial T} {ɛ}_{H 2 O}^{′} ( T , f ) + \frac{\partial }{\partial {ɛ}^{″}} p ( {ɛ}^{′} , {ɛ}^{″} ) \cdot \frac{\partial }{\partial T} {ɛ}_{H 2 O}^{″} ( T , f ) ) \cdot \frac{Δ T}{p ( {ɛ}^{′} , {ɛ}^{″} )} \vert < B \qquad ( 3.3 )$$

Advantageously, the threshold B should be less than 0.05, in particular less than 0.01, such that the errors in parameter p would be in an order below 5% or 1%, respectively.

For mammals, the temperature will typically range between 30 and 38° C., in particular close to the body surface, and therefore T can be set to 34° C. and ΔT to 4° C. Using these assumptions as well as the known dependence of the permittivity ε_{H20}(T, f) from [4], it is now possible to calculate, for a given function p(ε′, ε″) the range of the frequency f at which the condition of Eq. (3.3) is fulfilled. In most cases, the value p(ε′, ε″) in Eq. (3.3.) can be a “typical value” or “average value” of parameter p.

### 3. Applications

As mentioned, the present application is especially suited to quantify the levels of skin moisture and/or the level of body hydration, i.e. for cosmetics, industry, medical and military use.

The following list is by no means complete and only describes potential application areas:
Skin moisture assessment to monitor the skin-care product efficacy
Determination of normal and potentially pathologic situations of the skin
Hydration level monitoring of elderly persons
Biomarkers of hydration and renal status
   As mentioned, however, the invention is also suited for measuring other types of parameters p, such as blood glucose levels.

### REFERENCES

[1] C. P. Wen, “Coplanar Waveguide: A Surface Strip Transmission Line Suitable for Nonreciprocal Gyromagnetic Device Applications,” in IEEE Trans Microwave Theory Techn., December 1969, pp. 1087-1090.
[2] S. Gevorgian, L. J. P. Linnér, E. L. Kollberg, “CAD Models for Shielded Multilayered CPW,” in IEEE Trans Microwave Theory Techn., April 1995, pp. 772-779.
[3] Ch. M. Lee and H. I. Maibach, “Bioengineering Analysis of Water Hydration: An Overview”, in Exog. Dermatol, 2002, 269-275.
[4] U Kaatze, “Complex permittivity of water as a function of frequency and temperature,” J. Chem. Eng. Data, 1989, pp. 371-374
[5] N. Miura, N. Asaka, N. Shinyashiki, and S. Mishimo, “Microwave Dielectric Study on Bound Water of Globule Proteins in Aqueous Solution,” in Biopolymers 1994, pp. 357-364.
   [6] K. Fuchs and U. Kaatze, “Molecular Dynamics of Carbohydrate Aqueous Solutions. Dielectric Relaxation as a Function of Glucose and Fructose Concentration,” in J. Phys. Chem. 2001, pp. 20.36-2042.
   [7] Ellison, W., A. Balana, G. Delbos, K. Lamkaouchi, L. Eymard, C. Guillou, and C. Prigent, “New permittivity measurements of seawater,” Radio Science, vol. 33, pp. 639-648, 1998.
   [8] S. S. Bedair and I. Wolff, “Fast, Accurate and Simple Analytic Formulas for Calculating the Parameters of Supported Coplanar Waveguides for (M)MIC's,” in IEEE Trans. Microwave Theory Techn, vol. 40, January 1992, pp. 41-48.
   [9] M. D. Janezic, D. F. Williams, “Permittivivty Characterization from Transmission-Line Measurements,” in IEEE MTT-S Int Microwave Symposium Dig., June 197, pp. 1343-1346.
   [10] S. S. Stuchly and C. E. Bassey, “Microwave coplanar sensors for dielectric measurements,” in Meas Sci Technol., 1998, pp. 1324-1329.
   [11] A. Raj, W. S. Holmes, and S. R. Judah, “Wide Bandwidth Measurement of Complex Permittivity of Liquids using Coplanar Lines,” in IEE Trans. Instr. Meas., vol. 50, August 2001.
   [12] B. Kang, J. Cho, Ch. Cheon, Y. Kwon, “Nondestructive Measurements of Complex Permittivity and Permeability Using Multilayered Coplanar Waveguide Structures,” in IEEE Microwave Wireless Comp. Lett., vol. 15, May 2005

1. A device for measuring at least one parameter p depending on the real part ε′ and/or imaginary part ε″ of the permittivity of body tissue, in particular skin, of a mammal, said device comprising
a signal generator (6) generating an AC voltage at a frequency f,
an electrode arrangement (1, 2, 4) connected to said signal generator (6) for generating an alternating electric field in said tissue,
a measuring unit (7, 8, 10) connected to said electrode arrangement (1, 2, 4) for determining said parameter p, wherein said parameter p is a function p (ε′, ε″) depending on the real part ε′ and/or the imaginary part ε″ of said permittivity,
characterized in that said frequency f is such that
$$\vert ( \frac{\partial }{\partial {ɛ}^{′}} p ( {ɛ}^{′} , {ɛ}^{″} ) \cdot \frac{\partial }{\partial T} {ɛ}_{H 2 O}^{′} ( T , f ) + \frac{\partial }{\partial {ɛ}^{″}} p ( {ɛ}^{′} , {ɛ}^{″} ) \cdot \frac{\partial }{\partial T} {ɛ}_{H 2 O}^{″} ( T , f ) ) \cdot \frac{Δ T}{p ( {ɛ}^{′} , {ɛ}^{″} )} \vert < B$$
for a temperature T=34° C., a temperature deviation ΔT=4° C. and a threshold value B not larger than 0.05, wherein ε′_{H20}(T,f) and ε″_{H20} (T, f) are functions describing real and imaginary parts of the permittivity of water as a function of temperature T and frequency f.

2. The device of claim 1, wherein said threshold value B is not larger than 0.01.

3. A device, according to claim 1, for measuring at least one parameter p depending on the real part ε′ of the permittivity of body tissue, in particular skin, of a mammal, wherein said parameter p is substantially independent of the imaginary part ε″ of said permittivity, wherein said device comprises
a signal generator (6) generating an AC voltage at a frequency f,
an electrode arrangement (1, 2, 4) connected to said signal generator (6) for generating an alternating electric field in said tissue,
a measuring unit (7, 8, 10) connected to said electrode arrangement (1, 2, 4) for determining said parameter p,
wherein said frequency f is in a range between 6.2 and 10.1 GHz.

4. The device of claim 3, wherein said frequency f is between 7.2-9.2 GHz.

5. A device according to claim 1, for measuring at least one parameter p depending on the imaginary part ε″ of the permittivity of body tissue, in particular skin, of a of a mammal, wherein said parameter is substantially independent of the real part ε′ of said permittivity, wherein said device comprises
a signal generator (6) generating an AC voltage at a frequency f,
an electrode arrangement (1, 2, 4) connected to said signal generator (6) for generating an alternating electric field in said tissue,
a measuring unit (7, 8, 10) connected to said electrode arrangement (1, 2, 4) for determining said parameter p,
wherein said frequency f is in a range between 25.5 and 36 GHz.

6. The device of claim 5, wherein said frequency f is between 27.5 and 32.5 GHz, in particular 29.0 and 31.3 GHz.

7. The device of claim 1, wherein said electrode arrangement (1, 2, 4) comprises at least one coplanar waveguide.

8. A method for operating the device of claim 1, comprising the step choosing said frequency f such that
$$\vert ( \frac{\partial }{\partial {ɛ}^{′}} p ( {ɛ}^{′} , {ɛ}^{″} ) \cdot \frac{\partial }{\partial T} {ɛ}_{H 2 O}^{′} ( T , f ) + \frac{\partial }{\partial {ɛ}^{″}} p ( {ɛ}^{′} , {ɛ}^{″} ) \cdot \frac{\partial }{\partial T} {ɛ}_{H 2 O}^{″} ( T , f ) ) \cdot \frac{Δ T}{p ( {ɛ}^{′} , {ɛ}^{″} )} \vert < B$$
for a temperature T=34° C., a temperature deviation ΔT=4° C. and a threshold value B not larger than 0.05, wherein ε′_{H20}(T,f) and ε″_{H20} (T, f) are functions describing real and imaginary parts of the permittivity of water as a function of temperature T and frequency f.

9. The device of claim 3, wherein said frequency f is between 7.7 and 8.7 GHz.
